(19) United States
(12) Patent Application Publication
(10) Pub. No.: US 2026/0289312 A1
(43) Pub. Date: Sep. 24, 2026

(54) PROJECTION-BASED LANGUAGE MODEL PRUNING

(71) Applicant: Rakuten Mobile, Inc., Tokyo (JP)

(72) Inventors: Bailey ECCLES, St Andrews (GB); Blesson VARGHESE, St Andrews (GB); Jee Chang, Leon WONG, Tokyo (JP)

(21) Appl. No.: 19/082,179

(22) Filed: Mar. 18, 2025

(51) Int. Cl. G06N 3/082; G06N 3/04

(52) U.S. Cl. CPC G06N 3/082; G06N 3/04

(57) ABSTRACT

Projection-based language model pruning is implemented by performing inference of a batch of natural language samples using a language model, collecting activation values from each layer of the language model during inference, computing weight metric values for each parameter of each projection, estimating an importance value of each projection of the language model, normalizing an importance value distribution of the plurality of projections to obtain relative projection importance values, and pruning the language model based on the relative projection importance values.

### FIELD

The present disclosure relates to projection-based language model pruning.

### BACKGROUND

The information disclosed in this background section is only for enhancement of understanding of the general background of the disclosure and should not be taken as an acknowledgement or any form of suggestion that this information forms the prior art already known to a person skilled in the art.

Artificial Intelligence (AI) models such as large language models (LLMs) require a computational power available in data centers to train and deploy to end users. To deploy and run these large models directly to user devices, model compression techniques are used to reduce computational demand by systematically removing unused or redundant parts of the model. LLMs contain many different components of various sizes. Model pruning can prune any of these components in varying amounts.

### SUMMARY

Projection-based language model pruning is implemented by performing inference of a batch of natural language samples using a language model, collecting activation values from each layer among a plurality of projections of each layer among a plurality of layers of the language model during inference, computing weight metric values for each parameter among a plurality of parameters of each projection among the plurality of projections of each layer among the plurality of layers of the language model, each weight metric value based on a parameter value of the parameter and collected activation values corresponding to the layer of the parameter, estimating an importance value of each projection among the plurality of projections of each layer among the plurality of layers of the language model, the importance value based on a number of parameters among the plurality of parameters of the projection corresponding to a weight metric value that is greater than an average weight metric value of the plurality of parameters of the projection by a threshold factor, normalizing an importance value distribution of the plurality of projections of the plurality of layers of the language model to obtain relative projection importance values, the importance value distribution based on, for each projection among the plurality of projections of each layer among the plurality of layers of the language model, a ratio of the importance value to a total number of parameters among the plurality of parameters of the projection, and pruning the language model based on the relative projection importance values.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic diagram of a language model, according to at least some embodiments of the subject disclosure.

FIG. 2 is a schematic diagram of an attention block of a language model, according to at least some embodiments of the subject disclosure.

FIG. 3 is a schematic diagram of a feed-forward block of a language model, according to at least some embodiments of the subject disclosure.

FIG. 4 is an operational flow for projection-based language model pruning, according to at least some embodiments of the subject disclosure.

FIG. 5 is an operational flow for determining relative projection values, according to at least some embodiments of the subject disclosure.

FIG. 6 is an operational flow for pruning a model, according to at least some embodiments of the subject disclosure.

FIG. 7 illustrates an embodiment of apparatus 760 for projection-based language model pruning, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

In the present disclosure, specific tasks may be performed using AI/ML (Artificial Intelligence/Machine Learning) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

Technology within the model pruning domain known to the inventors is split into two categories. One category, referred to as unstructured pruning, focuses on maintaining the model's accuracy after pruning, typically preferring this over reducing computational load. Conversely, the other category, referred to as structured pruning, focuses on reducing the computational load of the model at the expense of model accuracy, typically by pruning large amounts of the model that contain essential neurons. In both categories, there is focus on pruning each component by the same amount, known as uniform pruning.

At least some embodiments of the subject disclosure balance these two categories, maintaining accuracy while improving the performance of the model. At least some embodiments of the subject disclosure include a method and system for selectively pruning each component by different amounts, referred to as non-uniform pruning. In at least some embodiments, non-uniform pruning identifies which components are the most important to the LLM and prunes the least important components more. In at least some embodiments, non-uniform pruning results in models that have higher accuracy than uniform pruning, providing room for performance-related pruning afterwards without reducing overall accuracy as much as prior art.

At least some embodiments of the subject disclosure allow for smaller, faster, and more accurate LLMs to be deployed on a wide range of user devices, such as personal computers, smartphones, etc. At least some embodiments enable offline or privacy-focused LLMs, which can be deployed on user devices without relying on sending data to public servers or anywhere else outside the user device.

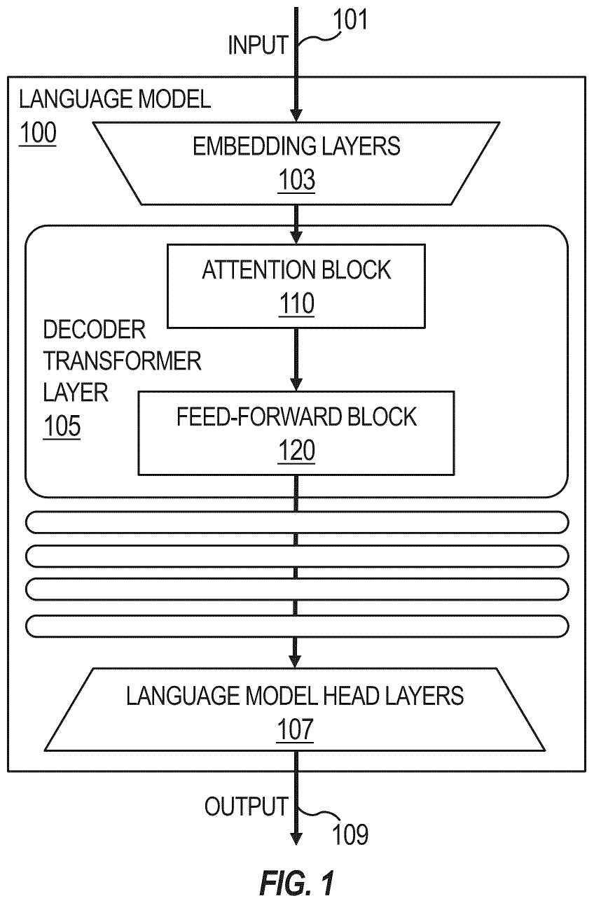

FIG. 1 is a schematic diagram of a language model 100, according to at least some embodiments of the subject disclosure. Language model 100 includes input 101, embedding layers 103, decoding transformer layer 105, attention block 110, feed-forward block 120, language model head layers 107, and output 109.

In at least some embodiments, language model 100 is a neural network model designed to process and generate natural language text. In at least some embodiments, language model 100 is configured to process data by transforming input text into meaningful representations and generating output text. In at least some embodiments, language model 100 performs these transformations through a series of layers and components that apply various algorithms and computations. In at least some embodiments, language model 100 is configured to process input text by converting the input text into token embeddings, refining these embeddings through multiple layers, and generating output text. In at least some embodiments, the plurality of layers of the language model are decoder transformer layers.

Input 101 represents data entered into language model 100. In at least some embodiments, input 101 is raw natural language text to be processed by the model. In at least some embodiments, input 101 is entered by a user. In at least some embodiments, input 101 is raw text that is fed into embedding layers 103 for tokenization and numerical representation.

Embedding layers 103 are initial layers of language model 103. In at least some embodiments, embedding layers 103 are configured to convert raw text into numerical tokens that the model can process. In at least some embodiments, embedding layers 103 are configured to transform input text into token embeddings and pass them to decoding transformer layers, such as decoding transformer layer 105. Decoding transformer layer 105 is one of a plurality of decoding transformer layers of language model 100. In at least some embodiments, decoding transformer layers, such as decoding transformer layer 105, are configured to process token embeddings to generate context-aware representations. In at least some embodiments, decoding transformer layers are configured to process and transform data through each layer. In at least some embodiments, decoding transformer layers are configured to apply a series of transformations and computations, such as attention functions, activation functions, etc. In at least some embodiments, decoding transformer layers are configured to utilize attention mechanisms and feed-forward networks to process embeddings and generate output tokens. In at least some embodiments, each decoder transformer layer among the plurality of layers includes an attention block and a feed forward block. In at least some embodiments, each decoding transformer layer, such as decoding transformer layer 105, includes an attention block, such as attention block 110, and a feed-forward block, such as feed-forward block 120, to refine token representations and pass results to subsequent layers. In at least some embodiments, the plurality of projections are within the attention block and the feed forward block of each decoder transformer layer.

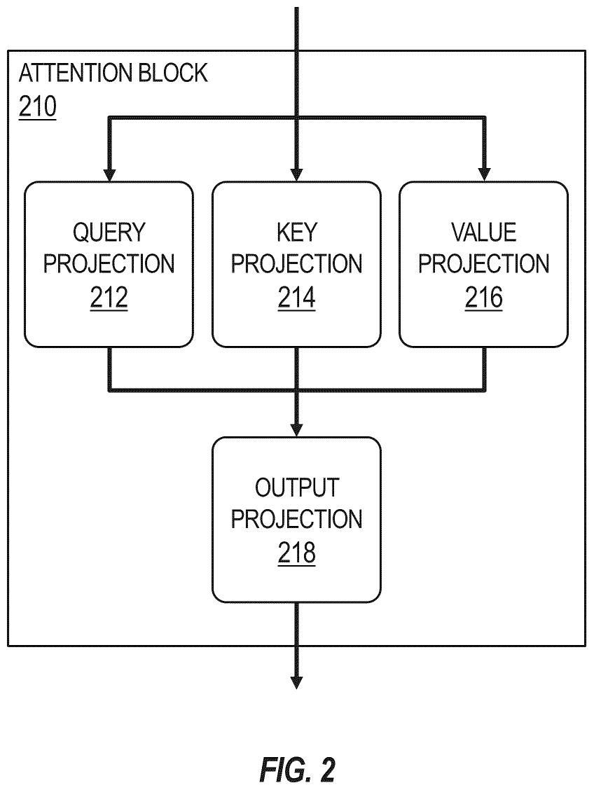

Attention block 110 is a component of decoding transformer layer 105. In at least some embodiments, attention block 110 is configured to calculate attention scores to determine the relevance of each token to others. In at least some embodiments, attention block 110 is configured to determine the importance of different data points relative to each other. In at least some embodiments, attention block 110 is configured to utilize algorithms to compute relevance scores between data points. In at least some embodiments, attention block 110 is made up of projections, such as shown and described with respect to FIG. 2.

Feed-forward block 120 is a component of decoding transformer layer 105. In at least some embodiments, feed-forward block 120 is configured to expand and refine attention scores into higher-dimensional representations. In at least some embodiments, feed-forward block 120 is configured to enhance and transform data representations. In at least some embodiments, feed-forward block 120 includes fully connected layers.

Language model head layers 107 are final layers of language model 100. In at least some embodiments, language model head layers 107 are configured to convert processed token representations back into natural language text. In at least some embodiments, language model head layers 107 are configured to convert processed data back into a human-readable or usable format. In at least some embodiments, language model head layers 107 are configured to receive refined token representations from decoding transformer layers, such as decoding transformer layer 105, and generate final output text.

Output 109 represents data produced by language model 100. In at least some embodiments, output 109 is the natural language text that is finally generated by the model. In at least some embodiments, output 109 is a response to input 101. In at least some embodiments, output 109 results from language model head layers 107.

FIG. 2 is a schematic diagram of an attention block 210 of a language model, according to at least some embodiments of the subject disclosure. Attention block 210 includes query projection 212, key projection 214, value projection 216, and output projection 218. The descriptions of attention block 110 with respect to FIG. 1 are generally applicable to attention block 210 unless in conflict with the following.

In at least some embodiments, attention block 210 is configured to utilize linear transformations to project input token representations into query, key, and value vectors, and then computing attention scores from these vectors. In at least some embodiments, attention block 210 is configured to calculate attention scores for each token, generating a matrix of attention scores.

Query projection 212 is a component of attention block 210. In at least some embodiments, query projection 212 is configured to project input tokens into query vectors for attention calculation. In at least some embodiments, query projection 212 comprises parameters, such as weights and biases, implemented as one or more linear layers.

Key projection 214 is a component of attention block 210. In at least some embodiments, key projection 214 is configured to project input tokens into key vectors for attention calculation. In at least some embodiments, key projection 214 comprises parameters, such as weights and biases, implemented as one or more linear layers.

Value projection 216 is a component of attention block 210. In at least some embodiments, value projection 216 is configured to project input tokens into value vectors for attention calculation. In at least some embodiments, value projection 216 comprises parameters, such as weights and biases, implemented as one or more linear layers.

Output projection 218 is a component of attention block 210. In at least some embodiments, output projection 218 is configured to project context vectors back into the original input space. In at least some embodiments, output projection 218 comprises parameters, such as weights and biases, implemented as one or more linear layers. In at least some embodiments, output projection 218 is configured to convert processed data back into the original format or another required format for subsequent layers. In at least some embodiments, output projection 218 is configured to receive context vectors from query projection 212, key projection 214, and value projection 216.

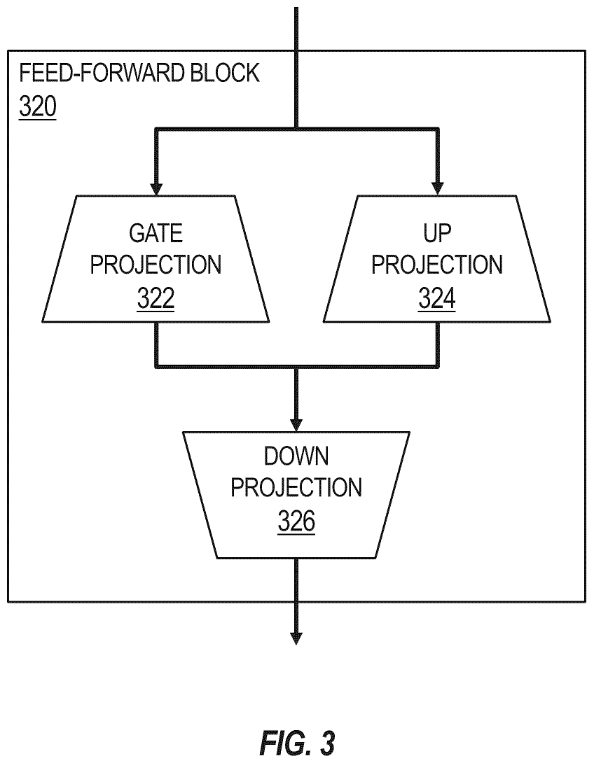

FIG. 3 is a schematic diagram of a feed-forward block 320 of a language model, according to at least some embodiments of the subject disclosure. Feed-forward block 320 includes gate projection 322, up projection 324, and down projection 326. The descriptions of feed-forward block 120 with respect to FIG. 1 are generally applicable to feed-forward block 320 unless in conflict with the following.

In at least some embodiments, feed-forward block 320 is configured to expand attention scores into a larger dimension. In at least some embodiments, feed-forward block 320 is configured to use matrix multiplication and activation functions to expand data dimensions.

Gate projection 322 is a component of feed-forward block 320. In at least some embodiments, gate projection 322 is configured to control the flow of data to up projection. In at least some embodiments, gate projection 322 comprises parameters, such as weights, that determine a gating function. In at least some embodiments, gate projection 322 is configured to control data flow in the language model.

Up projection 324 is a component of feed-forward block 320. In at least some embodiments, up projection 324 is configured to expand the dimensions of data. In at least some embodiments, up projection 324 comprises parameters, such as weights.

Down projection 326 is a component of feed-forward block 320. In at least some embodiments, down projection 326 is configured to shrink the dimensions of data back to the original size. In at least some embodiments, down projection 326 is made up of parameters, such as weights.

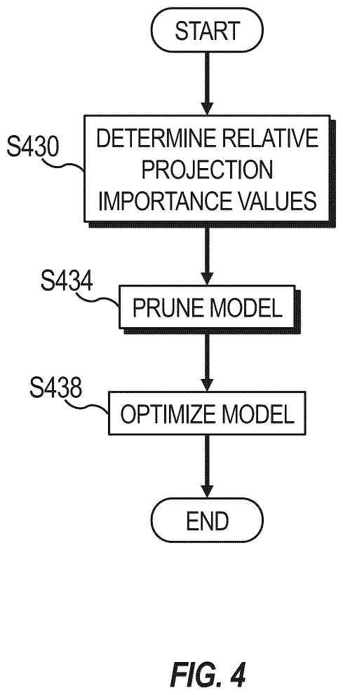

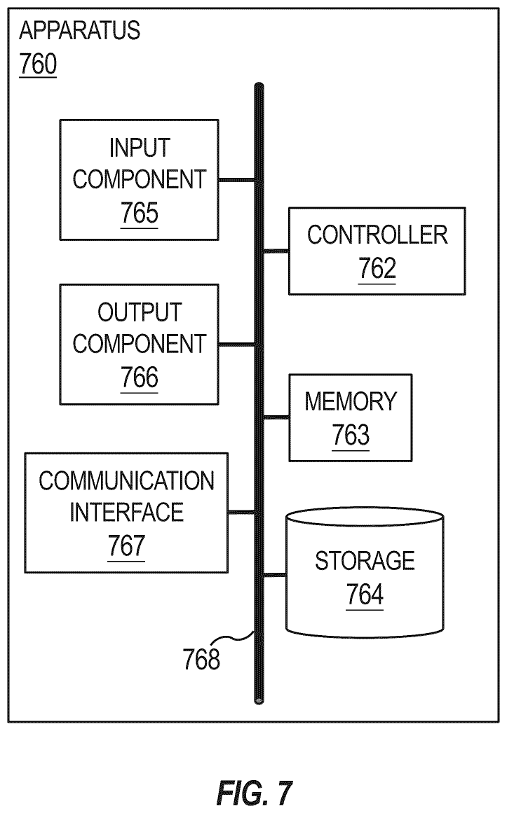

FIG. 4 is an operational flow for projection-based language model pruning, according to at least some embodiments of the subject disclosure. In at least some embodiments, the operational flow provides a method of projection-based language model pruning. In at least some embodiments, the method is performed by a controller of an apparatus, such as controller 762 of apparatus 760 of FIG. 7, described hereinafter.

At S430, the controller determines relative projection importance values. In at least some embodiments, the controller performs inference on a batch of natural language samples using the language model. In at least some embodiments, the controller collects activation values from each layer during inference. In at least some embodiments, the controller estimates the importance value of each projection based on weight metric values.

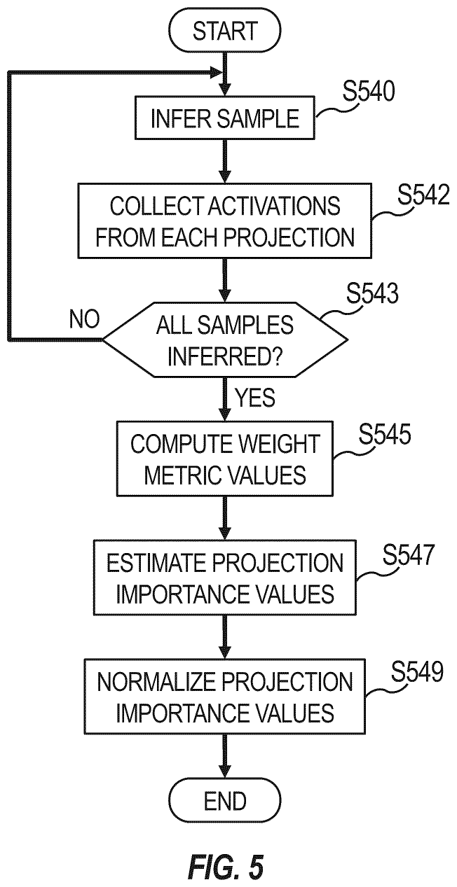

In at least some embodiments, the controller normalizes the importance value distribution to obtain relative projection importance values. In at least some embodiments, the controller operates according to user-defined batch size and threshold factor. In at least some embodiments, the controller stores the relative projection importance values. In at least some embodiments, the controller performs the operational flow of FIG. 5, described hereinafter.

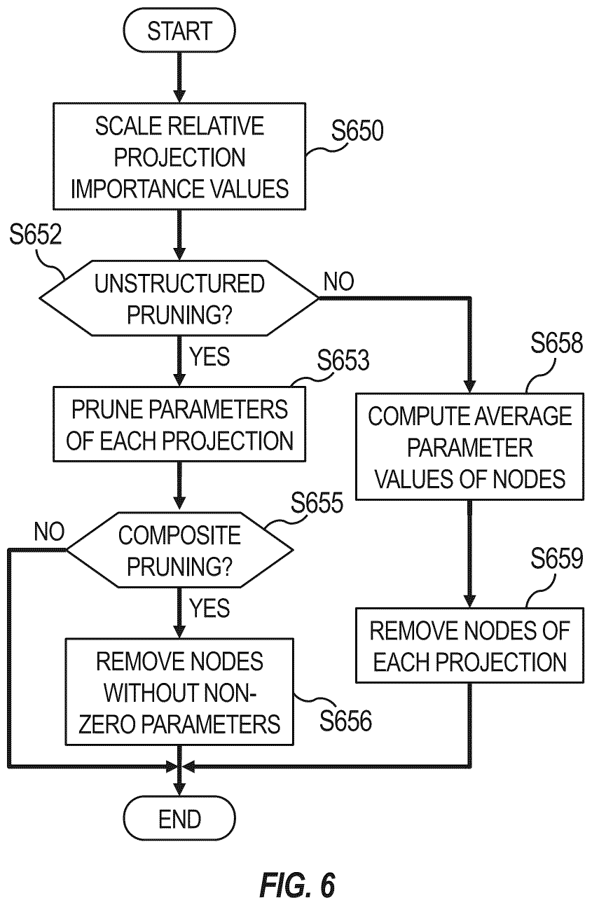

At S434, the controller prunes the model. In at least some embodiments, the controller scales the inverse of relative projection importance values according to the pruning target value. In at least some embodiments, the controller prunes the model based on relative projection importance values. In at least some embodiments, the controller prunes the language model based on the relative projection importance values. In at least some embodiments, the controller sets to zero a number of parameters equal to the projection pruning target value having the lowest parameter values. In at least some embodiments, the controller removes nodes no longer connected to non-zero parameters. In at least some embodiments, the controller utilizes relative projection importance values and the pruning target value to prune the language model. In at least some embodiments, the controller prunes the language model according to a plurality of pruning target values to obtain a plurality of pruned language models. In at least some embodiments, the controller operates according to a user-defined pruning target value. In at least some embodiments, the controller performs the operational flow of FIG. 6, described hereinafter.

At S438, the controller optimizes the model. In at least some embodiments, the controller retrains the pruned language model. In at least some embodiments, the controller quantizes the parameter size of the pruned language model. In at least some embodiments, the controller converts the parameter format of the pruned language model. In at least some embodiments, the controller utilizes the same training data as used to determine relative projection importance values. In at least some embodiments, the controller operates according to user-defined number of retraining iterations, quantization levels, or parameter formats. In at least some embodiments, the controller optimizes the pruned language model by performing at least one of retraining the pruned language model, quantizing a parameter size of the pruned language model, or converting a parameter format of the pruned language model.

FIG. 5 is an operational flow for determining relative projection values, according to at least some embodiments of the subject disclosure. In at least some embodiments, the operational flow provides a method of determining relative projection values. In at least some embodiments, the method is performed by a controller of an apparatus, such as controller 762 of apparatus 760 of FIG. 7, described hereinafter.

At S540, the controller infers the sample. In at least some embodiments, the controller loads a batch of natural language samples into memory. In at least some embodiments, the controller passes a sample through the language model to perform inference. In at least some embodiments, the controller performs inference of a batch of natural language samples using a language model.

At S542, the controller collects activations from each projection. In at least some embodiments, the controller hooks into the activation functions of each projection. In at least some embodiments, the controller transfers the activation values to a processing unit, such as the CPU. In at least some embodiments, the controller stores the collected activations for further processing. In at least some embodiments, the activation values are a proxy for the 12 norm term. In at least some embodiments, the controller collects activation values from each layer among a plurality of layers of the language model during inference.

At S543, the controller determines whether all samples have been inferred. In response to the controller determining that all samples have not been inferred, the operational flow returns to sample inference at S540. In response to the controller determining that all samples have been inferred, the operational flow proceeds to weight metric value computation at S545. In at least some embodiments, the controller first checks if all samples in the batch have been processed. In at least some embodiments, the controller utilizes a batch processing status.

At S545, the controller computes weight metric values. In at least some embodiments, the controller computes weight metric values for each parameter among a plurality of parameters of each projection among the plurality of projections of each layer among the plurality of layers of the language model, each weight metric value based on a parameter value of the parameter and collected activation values corresponding to the layer of the parameter. In at least some embodiments, the controller calculates the/2 norm value of the collected activations for each layer. In at least some embodiments, the computing of the weight metric values includes, for each weight metric value, computing an 12 norm value from the collected activation values corresponding to the layer of the parameter. In at least some embodiments, the controller multiplies each weight value of each projection by the 12 norm value of the layer. In at least some embodiments, the controller last flattens and concatenates the weight metric values across samples. In at least some embodiments, the controller operates according to the following formula:

$${ω}_{n , m} = {‖ {A}_{n} ‖}_{2} \cdot \vert {θ}_{n , m} \vert \qquad EQ . 1$$

where ω_{n,m} is the weight metric value of parameter θ_{n,m} in projection m in layer n, Aₙ is the activation values captured for layer n, ∥Aₙ∥₂ is the l₂ norm value of layer n, and θ_{n,m} is the parameter values of projection m in layer n.

At S547, the controller estimates projection importance values. In at least some embodiments, the controller estimates an importance value of each projection among the plurality of projections of each layer among the plurality of layers of the language model, the importance value based on a number of parameters among the plurality of parameters of the projection corresponding to a weight metric value that is greater than an average weight metric value of the plurality of parameters of the projection by a threshold factor. In at least some embodiments, the controller computes the mean of the weight metric values for each projection. In at least some embodiments, the controller compares the weight metric value of each parameter to the average weight metric value of parameters in the projection to identify outliers. In at least some embodiments, the controller identifies outliers for parameters that satisfy the following formula:

$$IsProjectionOutlier ( {θ}_{n , m}^{i} ) = {ω}_{n , m}^{i} > α \cdot \overline{{ω}_{n , m}} \qquad EQ . 2$$

where

$${ω}_{n , m}^{i}$$

is the weight metric value of a particular parameter

$${θ}_{n , m}^{i}$$

of projection m in layer n, ω̅_̅{̅n̅,̅m̅}̅ is the mean of the weight metric values in projection m, and α is the threshold factor.

At S549, the controller normalizes projection importance values. In at least some embodiments, the controller adjusts the importance values based on the total number of parameters in each projection. In at least some embodiments, the controller normalizes an importance value distribution of the plurality of projections of the plurality of layers of the language model to obtain relative projection importance values, the importance value distribution based on, for each projection among the plurality of projections of each layer among the plurality of layers of the language model, a ratio of the importance value to a total number of parameters among the plurality of parameters of the projection. In at least some embodiments, the controller calculates the ratio of outliers to total parameters in each projection. In at least some embodiments, the controller calculates the ratio of outliers to total parameters in each projection according to the following formula:

$${R}_{n , m} = \frac{{O}_{n , m}}{{C}_{n , m}} \cdot 100 \qquad EQ . 3$$

where R_{n,m} is the ratio of outliers to total parameters in projection m of layer n, O_{n,m} is the number of outliers in projection m in layer n, and C_{n,m} is the number of total parameters of projection m in layer n.

FIG. 6 is an operational flow for pruning a model, according to at least some embodiments of the subject disclosure. In at least some embodiments, the operational flow provides a method of pruning a model. In at least some embodiments, the method is performed by a controller of an apparatus, such as controller 762 of apparatus 760 of FIG. 7, described hereinafter.

At S650, the controller scales the relative projection importance values. In at least some embodiments, the pruning includes scaling an inverse of the relative projection importance values according to a pruning target value to obtain a projection pruning target value for each projection of the language model. In at least some embodiments, the controller retrieves relative projection importance values. In at least some embodiments, the controller calculates a scaling factor based on the pruning target. In at least some embodiments, the controller applies the scaling factor to an inverse of the importance values. In at least some embodiments, the controller operates according to a user-defined pruning target.

At S652, the controller determines whether to perform unstructured pruning. In response to the controller determining to perform unstructured pruning, the operational flow proceeds to parameter pruning at S653. In response to the controller determining not to perform unstructured pruning, the operational flow proceeds to average parameter value computation at S658. In at least some embodiments, the controller determines whether to perform unstructured pruning according to a user-selected option. In at least some embodiments, the controller determines whether to perform unstructured pruning according to a target device for performing inference. In at least some embodiments, the controller determines whether to perform unstructured pruning according to processing capability and available memory of the target device.

At S653, the controller prunes the parameters of each projection. In at least some embodiments, the controller identifies parameters having the lowest values of each projection for pruning. In at least some embodiments, the controller sets the identified parameters to zero. In at least some embodiments, the pruning further includes setting, for each projection, a number of parameters equal to the projection pruning target value having the lowest parameter values.

At S655, the controller determines whether to perform composite pruning. In response to the controller determining to perform composite pruning, the operational flow proceeds to node removal at S656. In response to the controller determining not to perform composite pruning, the operational flow ends. In at least some embodiments, the controller determines whether to perform composite pruning according to a user-selected option. In at least some embodiments, the controller determines whether to perform composite pruning according to a target device for performing inference. In at least some embodiments, the controller determines whether to perform composite pruning according to processing capability and available memory of the target device.

At S656, the controller removes nodes without non-zero parameters. In at least some embodiments, the controller identifies nodes in which all connected parameters are set to zero. In at least some embodiments, the controller checks corresponding nodes to verify that all connected parameters are set to zero. In at least some embodiments, the controller removes the identified nodes from the model. In at least some embodiments, the pruning further includes removing, for each projection, a number of nodes among a plurality of nodes of the projection that are no longer connected to any non-zero parameters. In at least some embodiments, the controller restructures the model after removal of the nodes. Once operation S656 is complete, the operational flow ends.

At S658, the controller computes average parameter values of nodes. In at least some embodiments, the controller computes, for each node among a plurality of nodes of each projection, an average parameter value among parameters that are connected to the node. In at least some embodiments, the controller calculates the average parameter value for each node in the projections of the model. In at least some embodiments, the controller stores the average parameter value for each node.

At S659, the controller removes nodes of each projection. In at least some embodiments, the pruning further includes removing, for each projection, a number of nodes among the plurality of nodes equal to the projection pruning target value having the lowest average parameter values. In at least some embodiments, the controller identifies nodes with the lowest average parameter values for removal. In at least some embodiments, the controller removes the identified nodes from the model. In at least some embodiments, the controller utilizes average parameter values and the pruning target. In at least some embodiments, the controller varies the number of nodes to remove and the threshold for removal. In at least some embodiments, the controller restructures the model after removal of the nodes.

FIG. 7 illustrates an embodiment of apparatus 760 for projection-based language model pruning, according to at least some embodiments of the subject disclosure. As shown in FIG. 7, apparatus 760 includes controller 762, memory 763, storage 764, input component 765, output component 766, communication interface 767, and bus 768. Controller 762, as used herein, means any type of computational circuit that may comprise hardware elements and software elements, controller 762 may be embodied as a multi-core processor, a single core processor, or a combination of one or more multi-core processors and/or one or more single core processors, a distributed processing system, or the like. controller 762 may be a Central Processing Unit (CPU), a graphics processing unit (GPU), an accelerated processing unit (APU), an application-specific integrated circuit (ASIC), or another type of processing component.

Memory 763 includes a non-transitory computer readable medium. memory 763 includes a random-access memory (RAM), a read only memory (ROM), and/or another type of dynamic or static storage device (e.g., a flash memory, a magnetic memory, and/or an optical memory) that stores information and/or instructions for use by controller 762. The memory 763 comprises machine-readable instructions which are executable by controller 762. These machine-readable instructions when executed by controller 762 cause controller 762 to perform one or more method steps of an embodiment described above.

Storage 764 stores information and/or software related to the operation and use of the apparatus 760. For example, storage 764 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 765 is configured to receive information, such as user input. For example, the input component 765 may include, but not be limited to, a touch screen display, a keyboard, a keypad, a mouse, a button, a switch, and/or a microphone. Additionally, or alternatively, the input component 765 may include a sensor for sensing information (e.g., a global positioning system (GPS), an accelerometer, a gyroscope, and/or an actuator).

Output component 766 is configured to provide output information from the apparatus 760. For example, the output component 766 may be, but not limited to, a display, a speaker, an instruction device to an external device, and/or one or more light-emitting diodes (LEDs).

Communication interface 767 is an interface that provides a communication connection to other devices, such as external devices and internal devices. The connection by the communication interface 767 can be a wired connection, a wireless connection, or a combination of wired and wireless connections, and can be a direct connection or an indirect connection via a communication network that exists between apparatus 760 and other devices. In other words, the standard of the communication interface 767 is not limited.

Bus 768 acts as an interconnect between controller 762, memory 763, storage 764, the input component 765, the output component 766, and the communication interface 767 of apparatus 760. The bus 768 may include a wired interconnection or a wireless interconnection.

The number and arrangement of components shown in FIG. 7 are provided as an example. In practice, apparatus 760 may include additional components, fewer components, different components, or differently arranged components than those shown in FIG. 7. Additionally, or alternatively, a set of components (e.g., one or more components) of apparatus 760 may perform one or more functions described as being performed by another set of components of apparatus 760. Further, one or more method steps described in any of the embodiments may be performed utilizing a plurality of apparatus 760 in communication with one another.

In at least some embodiments, projection-based language model pruning is implemented by a non-transitory computer-readable medium including instructions that, in response to execution by one or more processors, causes performance of operations. The operations comprise performing inference of a batch of natural language samples using a language model. The operations further comprise collecting activation values from each layer among a plurality of layers of the language model during inference. The operations further comprise computing weight metric values for each parameter among a plurality of parameters of each projection among the plurality of projections of each layer among the plurality of layers of the language model, each weight metric value based on a parameter value of the parameter and collected activation values corresponding to the layer of the parameter. The operations further comprise estimating an importance value of each projection among the plurality of projections of each layer among the plurality of layers of the language model, the importance value based on a number of parameters among the plurality of parameters of the projection corresponding to a weight metric value that is greater than an average weight metric value of the plurality of parameters of the projection by a threshold factor. The operations further comprise normalizing an importance value distribution of the plurality of projections of the plurality of layers of the language model to obtain relative projection importance values, the importance value distribution based on, for each projection among the plurality of projections of each layer among the plurality of layers of the language model, a ratio of the importance value to a total number of parameters among the plurality of parameters of the projection. The operations further comprise pruning the language model based on the relative projection importance values.

In at least some embodiments, the pruning includes scaling an inverse of the relative projection importance values according to a pruning target value to obtain a projection pruning target value for each projection of the language model. In at least some embodiments, the pruning further includes setting, for each projection, a number of parameters equal to the projection pruning target value having the lowest parameter values. In at least some embodiments, the pruning further includes removing, for each projection, a number of nodes among a plurality of nodes of the projection that are no longer connected to any non-zero parameters. In at least some embodiments, projection-based language model pruning is further implemented by computing, for each node among a plurality of nodes of each projection, an average parameter value among parameters that are connected to the node; wherein the pruning further includes removing, for each projection, a number of nodes among the plurality of nodes equal to the projection pruning target value having the lowest average parameter values. In at least some embodiments, projection-based language model pruning is further implemented by optimizing the pruned language model by performing at least one of retraining the pruned language model, quantizing a parameter size of the pruned language model, or converting a parameter format of the pruned language model. In at least some embodiments, projection-based language model pruning is further implemented by storing the relative projection importance values, and pruning the language model according to a plurality of pruning target values to obtain a plurality of pruned language models. In at least some embodiments, the plurality of layers of the language model are decoder transformer layers. In at least some embodiments, each decoder transformer layer among the plurality of layers includes an attention block and a feed forward block; and wherein the plurality of projections are within the attention block and the feed forward block of each decoder transformer layer. In at least some embodiments, the computing of the weight metric values includes, for each weight metric value, computing an/2 norm value from the collected activation values corresponding to the layer of the parameter.

In at least some embodiments, projection-based language model pruning is implemented by a method. The method comprises performing inference of a batch of natural language samples using a language model. The method further comprises collecting activation values from each layer among a plurality of layers of the language model during inference. The method further comprises computing weight metric values for each parameter among a plurality of parameters of each projection among the plurality of projections of each layer among the plurality of layers of the language model, each weight metric value based on a parameter value of the parameter and collected activation values corresponding to the layer of the parameter. The method further comprises estimating an importance value of each projection among the plurality of projections of each layer among the plurality of layers of the language model, the importance value based on a number of parameters among the plurality of parameters of the projection corresponding to a weight metric value that is greater than an average weight metric value of the plurality of parameters of the projection by a threshold factor. The method further comprises normalizing an importance value distribution of the plurality of projections of the plurality of layers of the language model to obtain relative projection importance values, the importance value distribution based on, for each projection among the plurality of projections of each layer among the plurality of layers of the language model, a ratio of the importance value to a total number of parameters among the plurality of parameters of the projection. The method further comprises pruning the language model based on the relative projection importance values.

In at least some embodiments, the pruning includes scaling an inverse of the relative projection importance values according to a pruning target value to obtain a projection pruning target value for each projection of the language model. In at least some embodiments, the pruning further includes setting, for each projection, a number of parameters equal to the projection pruning target value having the lowest parameter values. In at least some embodiments, the pruning further includes removing, for each projection, a number of nodes among a plurality of nodes of the projection that are no longer connected to any non-zero parameters. In at least some embodiments, projection-based language model pruning further includes computing, for each node among a plurality of nodes of each projection, an average parameter value among parameters that are connected to the node; wherein the pruning further includes removing, for each projection, a number of nodes among the plurality of nodes equal to the projection pruning target value having the lowest average parameter values. In at least some embodiments, projection-based language model pruning is further implemented by optimizing the pruned language model by performing at least one of retraining the pruned language model, quantizing a parameter size of the pruned language model, or converting a parameter format of the pruned language model. In at least some embodiments, projection-based language model pruning is further implemented by storing the relative projection importance values, and pruning the language model according to a plurality of pruning target values to obtain a plurality of pruned language models. In at least some embodiments, the plurality of layers of the language model are decoder transformer layers. In at least some embodiments, each decoder transformer layer among the plurality of layers includes an attention block and a feed forward block; and wherein the plurality of projections are within the attention block and the feed forward block of each decoder transformer layer. In at least some embodiments, the computing of the weight metric values includes, for each weight metric value, computing an 12 norm value from the collected activation values corresponding to the layer of the parameter.

In at least some embodiments, projection-based language model pruning is implemented by a controller comprising circuitry configured to perform operations. The operations comprise performing inference of a batch of natural language samples using a language model. The operations further comprise collecting activation values from each layer among a plurality of layers of the language model during inference. The operations further comprise computing weight metric values for each parameter among a plurality of parameters of each projection among the plurality of projections of each layer among the plurality of layers of the language model, each weight metric value based on a parameter value of the parameter and collected activation values corresponding to the layer of the parameter. The operations further comprise estimating an importance value of each projection among the plurality of projections of each layer among the plurality of layers of the language model, the importance value based on a number of parameters among the plurality of parameters of the projection corresponding to a weight metric value that is greater than an average weight metric value of the plurality of parameters of the projection by a threshold factor. The operations further comprise normalizing an importance value distribution of the plurality of projections of the plurality of layers of the language model to obtain relative projection importance values, the importance value distribution based on, for each projection among the plurality of projections of each layer among the plurality of layers of the language model, a ratio of the importance value to a total number of parameters among the plurality of parameters of the projection. The operations further comprise pruning the language model based on the relative projection importance values.

In at least some embodiments, the pruning includes scaling an inverse of the relative projection importance values according to a pruning target value to obtain a projection pruning target value for each projection of the language model. In at least some embodiments, the pruning further includes setting, for each projection, a number of parameters equal to the projection pruning target value having the lowest parameter values. In at least some embodiments, the pruning further includes removing, for each projection, a number of nodes among a plurality of nodes of the projection that are no longer connected to any non-zero parameters. In at least some embodiments, projection-based language model pruning further includes computing, for each node among a plurality of nodes of each projection, an average parameter value among parameters that are connected to the node; wherein the pruning further includes removing, for each projection, a number of nodes among the plurality of nodes equal to the projection pruning target value having the lowest average parameter values. In at least some embodiments, projection-based language model pruning is further implemented by optimizing the pruned language model by performing at least one of retraining the pruned language model, quantizing a parameter size of the pruned language model, or converting a parameter format of the pruned language model. In at least some embodiments, projection-based language model pruning is further implemented by storing the relative projection importance values; pruning the language model according to a plurality of pruning target values to obtain a plurality of pruned language models. In at least some embodiments, the plurality of layers of the language model are decoder transformer layers. In at least some embodiments, each decoder transformer layer among the plurality of layers includes an attention block and a feed forward block; and wherein the plurality of projections are within the attention block and the feed forward block of each decoder transformer layer. In at least some embodiments, the computing of the weight metric values includes, for each weight metric value, computing an 12 norm value from the collected activation values corresponding to the layer of the parameter.

What is claimed is:

1. A non-transitory computer-readable medium including instructions that, in response to execution by one or more processors, causes performance of operations comprising:
performing inference of a batch of natural language samples using a language model;
collecting activation values from each layer among a plurality of layers of the language model during inference;
computing weight metric values for each parameter among a plurality of parameters of each projection among the plurality of projections of each layer among the plurality of layers of the language model, each weight metric value based on a parameter value of the parameter and collected activation values corresponding to the layer of the parameter;
estimating an importance value of each projection among the plurality of projections of each layer among the plurality of layers of the language model, the importance value based on a number of parameters among the plurality of parameters of the projection corresponding to a weight metric value that is greater than an average weight metric value of the plurality of parameters of the projection by a threshold factor;
normalizing an importance value distribution of the plurality of projections of the plurality of layers of the language model to obtain relative projection importance values, the importance value distribution based on, for each projection among the plurality of projections of each layer among the plurality of layers of the language model, a ratio of the importance value to a total number of parameters among the plurality of parameters of the projection; and
pruning the language model based on the relative projection importance values.

2. The computer-readable medium of claim 1, wherein the pruning includes scaling an inverse of the relative projection importance values according to a pruning target value to obtain a projection pruning target value for each projection of the language model.

3. The computer-readable medium of claim 2, wherein the pruning further includes setting, for each projection, a number of parameters equal to the projection pruning target value having the lowest parameter values.

4. The computer-readable medium of claim 3, wherein the pruning further includes removing, for each projection, a number of nodes among a plurality of nodes of the projection that are no longer connected to any non-zero parameters.

5. The computer-readable medium of claim 2, wherein the operations further comprise
computing, for each node among a plurality of nodes of each projection, an average parameter value among parameters that are connected to the node;
wherein the pruning further includes removing, for each projection, a number of nodes among the plurality of nodes equal to the projection pruning target value having the lowest average parameter values.

6. The computer-readable medium of claim 1, wherein the operations further comprise
optimizing the pruned language model by performing at least one of retraining the pruned language model, quantizing a parameter size of the pruned language model, or converting a parameter format of the pruned language model.

7. The computer-readable medium of claim 1, wherein the operations further comprise
storing the relative projection importance values; and
pruning the language model according to a plurality of pruning target values to obtain a plurality of pruned language models.

8. The computer-readable medium of claim 1, wherein the plurality of layers of the language model are decoder transformer layers.

9. The computer-readable medium of claim 8,
wherein each decoder transformer layer among the plurality of layers includes an attention block and a feed forward block; and
wherein the plurality of projections are within the attention block and the feed forward block of each decoder transformer layer.

10. The computer-readable medium of claim 1, wherein the computing of the weight metric values includes, for each weight metric value, computing an 12 norm value from the collected activation values corresponding to the layer of the parameter.

11. A method comprising:
performing inference of a batch of natural language samples using a language model;
collecting activation values from each layer among a plurality of layers of the language model during inference;
computing weight metric values for each parameter among a plurality of parameters of each projection among the plurality of projections of each layer among the plurality of layers of the language model, each weight metric value based on a parameter value of the parameter and collected activation values corresponding to the layer of the parameter;
estimating an importance value of each projection among the plurality of projections of each layer among the plurality of layers of the language model, the importance value based on a number of parameters among the plurality of parameters of the projection corresponding to a weight metric value that is greater than an average weight metric value of the plurality of parameters of the projection by a threshold factor;
normalizing an importance value distribution of the plurality of projections of the plurality of layers of the language model to obtain relative projection importance values, the importance value distribution based on, for each projection among the plurality of projections of each layer among the plurality of layers of the language model, a ratio of the importance value to a total number of parameters among the plurality of parameters of the projection; and
pruning the language model based on the relative projection importance values.

12. The method of claim 11, wherein the pruning includes scaling an inverse of the relative projection importance values according to a pruning target value to obtain a projection pruning target value for each projection of the language model.

13. The method of claim 11, wherein the pruning further includes setting, for each projection, a number of parameters equal to the projection pruning target value having the lowest parameter values.

14. The method of claim 11, wherein the pruning further includes removing, for each projection, a number of nodes among a plurality of nodes of the projection that are no longer connected to any non-zero parameters.

15. The method of claim 11, further comprising
computing, for each node among a plurality of nodes of each projection, an average parameter value among parameters that are connected to the node;
wherein the pruning further includes removing, for each projection, a number of nodes among the plurality of nodes equal to the projection pruning target value having the lowest average parameter values.

16. A device comprising:
a controller comprising circuitry configured to perform operations comprising, performing inference of a batch of natural language samples using a language model,
collecting activation values from each layer among a plurality of layers of the language model during inference,
computing weight metric values for each parameter among a plurality of parameters of each projection among the plurality of projections of each layer among the plurality of layers of the language model, each weight metric value based on a parameter value of the parameter and collected activation values corresponding to the layer of the parameter,
estimating an importance value of each projection among the plurality of projections of each layer among the plurality of layers of the language model, the importance value based on a number of parameters among the plurality of parameters of the projection corresponding to a weight metric value that is greater than an average weight metric value of the plurality of parameters of the projection by a threshold factor,
normalizing an importance value distribution of the plurality of projections of the plurality of layers of the language model to obtain relative projection importance values, the importance value distribution based on, for each projection among the plurality of projections of each layer among the plurality of layers of the language model, a ratio of the importance value to a total number of parameters among the plurality of parameters of the projection, and
pruning the language model based on the relative projection importance values.

17. The device of claim 16, wherein the pruning includes scaling an inverse of the relative projection importance values according to a pruning target value to obtain a projection pruning target value for each projection of the language model.

18. The device of claim 16, wherein the pruning further includes setting, for each projection, a number of parameters equal to the projection pruning target value having the lowest parameter values.

19. The device of claim 16, wherein the pruning further includes removing, for each projection, a number of nodes among a plurality of nodes of the projection that are no longer connected to any non-zero parameters.

20. The device of claim 16, wherein the operations further comprise
computing, for each node among a plurality of nodes of each projection, an average parameter value among parameters that are connected to the node;
wherein the pruning further includes removing, for each projection, a number of nodes among the plurality of nodes equal to the projection pruning target value having the lowest average parameter values.
